(19) United States
(12) Patent Application Publication
(10) Pub. No.: US 2003/0198780 A1
(43) Pub. Date: Oct. 23, 2003

(54) Resin formulation

(76) Inventors: John A. Campese, Newton, IA (US); Peter J. Fritz, Pella, IA (US)

Correspondence Address: FAEGRE & BENSON LLP, 2200 WELLS FARGO CENTER, 90 SOUTH 7TH STREET, MINNEAPOLIS, MN, 55402, US

(21) Appl. No.: 10/124,292

(22) Filed: Apr. 17, 2002

(51) Int. Cl. B32B 1/00

(52) U.S. Cl. 428/141

(57) ABSTRACT

The invention provides a composite part comprising a matrix and coated, hollow microspheres. The coated, hollow microspheres are generally polymeric spheres with an inorganic exterior coating such as calcium carbonate. In one embodiment, the composite part is a fenestration component formed by a pultrusion process, and may include reinforcing fiber material such as roving or mat. In some embodiments, the matrix is made from a curable precursor that includes a thermosetting resin and coated, hollow microspheres. A method for making a pultruded composite part incorporating coated, hollow microspheres is also provided.

The present invention relates to a composite part that contains coated, hollow microspheres dispersed throughout a resin-based matrix, and a pultrusion method for making the composite part. The composite part has reduced surface roughness in some embodiments, which prevents defects from arising in a finished surface. The composite part also possesses other desirable qualities, such as decreased density and weight, and reduced propensity for thermal shrinkage. The composite part may especially be useful as a fenestration component.

### BACKGROUND

Fenestration technology has seen a growing emphasis on the use of synthetic materials, which provide greater durability for weathering and increased resistance to decay than natural materials, among other benefits. Manufacturing processes that are suitable for producing fenestration components from synthetic materials such as polymers include extrusion and pultrusion, for example.

Pultrusion is a known technique in which longitudinally continuous fibrous elements, such as reinforcing fibers and/or mats, are combined into a resin-based composite. The pultrusion process generally involves pulling reinforcing fibers and/or reinforcing mats through a bath of resin, such as a thermoset resin, and then into a forming die. Heat from the die may be used to cure the resin as the part is pulled through the die on a continuous basis. The forming die also imparts a profile to the pultruded part.

The mat and reinforcing fiber are typically flexible and conformable textile products since they need to conform to the profile of the die. The mat and reinforcing fiber are typically glass-based products, while the resin is usually, but not necessarily, a thermosetting polyester. Mat material is generally in the form of a non-woven, felt-like web having glass fibers randomly placed in a planar swirl pattern.

During the pultrusion process, reinforcing fibers typically referred to as rovings comprise groupings of hundreds or thousands of filaments of micron-sized fibers, that mechanically behave like flexible strands. The filaments are flexible because the diameter of each filament is so small. The flexibility of the individual filaments imparts sufficient flexibility to the reinforcing fibers to fulfill the processing requirements of pultrusion. In a pultrusion profile, the mats and rovings constitute the reinforcement, while the resin constitutes the binder of the solid composite. After pultrusion, the rovings are held together by the resin-based matrix. The rovings, mat and resin matrix provide the pultruded part with rigidity.

Reinforced composite materials including either thermosetting resin or thermoplastic resin and reinforcing fibers are known. U.S. Pat. No. 5,455,090 to Da Re, et al. is directed to a composite tubular material having a fiber core impregnated with thermosetting resin. U.S. Pat. No. 5,948,505 to Puppin, et al. is directed to a composite member made from a thermoplastic resin and a reinforcing glass fabric. The member can be formed by an extrusion process and can be shaped to have a desired profile. U.S. Pat. No. 5,585,155 to Heikkila, et al. is directed to a composite structural member having a thermoplastic core extruded to form a profile and an exterior reinforcing layer of a fiber-reinforced cured thermoset resin.

Composite structures having reduced density have also been reported. U.S. Pat. No. 5,876,641 to LeClair, et al. is directed to a method for producing a pultruded composite profile structure injected with a foam material. The foam material is incorporated to provide different insulating and structural characteristics to the composite structure. U.S. Pat. No. 6,054,207 to Finley, et al. is directed to structural components made from an open-cell foamed thermoplastic material and wood fiber. The structural component may be formed to have a profile.

Composites incorporating microspheres in a thermosetting resin are described in U.S. Pat. No. 5,403,655 to Deviney, et al. Microspheres made from thermoplastic resins and having surface functional groups for bonding with the thermoset resin are preferred for these composites. U.S. Pat. No. 5,167,870 to Boyd, et al. is directed to preimpregnated heat-curable precursor material (“prepreg”) having reinforcing fibers and a curable matrix resin. This precursor material may be combined with hollow microspheres and cured to produce a syntactic foam product.

Composite materials incorporating inorganic hollow microspheres are also known. U.S. Pat. No. 4,273,806 to Stechler is directed to a method for forming an electrically insulating material from a thermoplastic resin and hollow microspheres of inorganic silica-alumina material. U.S. Pat. No. 3,917,547 to Massey reports the incorporation of inorganic silica-alumina “cenospheres” (irregularly shaped hollow particles) into a polyurethane foam.

A composite structural member comprising a polyolefin and wood fiber that is used in forming fenestration components is described in U.S. Pat. No. 6,265,037 to Godavarti, et al. The polyolefin composition from which the composite member is made may include fillers such as, for example, titanium dioxide, silica, alumina, calcium carbonate, glass beads, glass microspheres or ceramic microspheres. The composite member may be extruded to form a profile.

A metal-and-plastic composite section for use in fenestration components is described in U.S. Pat. No. 5,727,356 to Ensinger, et al. The composite section comprises two metal parts attached by a plastic insulating web containing heat-resistant fibers. The plastic insulating web preferably includes a thermosetting plastic, and can also include reinforcement fibers such as glass fibers, or flameproof agents such as antimony trioxide powder, aluminum hydroxide powder, halogenated organic compounds or swelling agents such as hollow microspheres of silicate, polypropylene or polyethylene containing blowing agents.

### SUMMARY OF THE INVENTION

The present invention, in one embodiment, is a pultruded composite part including coated, hollow microspheres as a component. The pultruded composite part may especially be useful as a fenestration component. Reinforcing mat or roving, or both, may optionally be included in the composite part for added strength.

In a second embodiment, the present invention provides a composite part having a matrix and a plurality of coated, hollow microspheres dispersed throughout the matrix. The composite part of this embodiment has reduced surface roughness, which prevents surface defects from arising on a finished surface. The composite part may especially be useful as a fenestration component having a finished surface.

In another embodiment, the present invention provides a precursor that is useful for forming the composite parts of the present invention. The precursor is a mixture of a thermosetting resin, a plurality of coated, hollow microspheres, and a low-profile additive.

The invention also provides a fenestration component having a matrix including coated, hollow microspheres. In some embodiments, the matrix of the fenestration component is reinforced by mat or roving, or both.

In yet another embodiment, the present invention includes a method for making a pultruded composite part. The method comprises shaping roving to provide a shaped reinforcement; contacting the shaped reinforcement with a curable composition including coated, hollow microspheres to provide an impregnated reinforcement; pulling the impregnated reinforcement into a die to provide a green part; and curing the green part in the die to make a pultruded composite part. The precursor of the present invention may be used as the curable composition in the practice of this method. A reinforcing mat may additionally be used in the practice of this method. The pultruded composite part is especially useful as a fenestration component.

### BRIEF DESCRIPTION OF THE SEVERAL VIEWS OF THE DRAWING

The invention will be described, in part, with the accompanying drawings:

FIG. 1 is a schematic, cross-sectional view of a pultruded part in accordance with the present invention.

FIG. 1A is an enlarged a portion of the pultruded part shown in FIG. 1.

FIG. 2 is a schematic, cross-sectional view of a pultruded part in accordance with the present invention.

FIG. 2A is a schematic illustration of an alternate pultruded part in accordance with the present invention.

FIG. 3 is a schematic illustration of a pultrusion process and equipment for carrying out a method of the present invention.

### DETAILED DESCRIPTION OF THE INVENTION

Numerous fenestration and non-fenestration parts and products may be made using the present invention. As used herein, the phrases “fenestration products,” “fenestration parts” or “fenestration components” refer interchangeably to windows, doors, skylights, shutters, and components thereof, such as for example window jambs, sills, heads, sash stiles, sash rails, muntins, mull parts, door thresholds, and the like. Non-fenestration parts that may be made using the compositions and methods of the present invention include, for example, automotive body components such as bumpers, dashboards, doors or hoods, composite pipe and pipe fittings, bathtubs, fluid tanks, equipment housings, electrical boxes and insulating materials.

The terms “matrix” or “matrix material” are used interchangeably herein to mean a cured or partially cured thermoset material, or a thermoplastic material in solid state, and including other materials such as, for example, filler or a microsphere component. The terms “resin” or “resin material” are used interchangeably to mean an uncured crosslinkable material (such as a thermoset resin), or a thermoplastic material at a temperature at which it can flow.

The phrases “precursor” or “precursor composition” are used interchangeably herein to mean any mixture including resin material and a microsphere component, prior to curing or solidification of the resin material to form a matrix. The phrase “precursor resin” as used herein means only the resin or resin material of a precursor composition.

The phrase “composite part” is used herein to mean a molded article comprising a matrix material. The phrase “pultruded composite part” is used herein to mean a composite part manufactured by a pultrusion process.

The phrase “reinforcing fiber” as used herein means a single filament such as a monofilament, or a grouping of a plurality of pliable, cohesive threadlike filaments. Although the Figures illustrate the reinforcing fibers schematically as a single entity or structure, each discrete reinforcing fiber illustrated herein may represent either a single filament, such as a monofilament, or a group of filaments. The term “roving” as used herein means a plurality of reinforcing fibers. Rovings are typically not twisted or kinked so that maximum longitudinal strength is maintained.

The pultruded composite parts of this invention generally have a longitudinal axis and a uniform cross-section orthogonal to the longitudinal axis. The composite parts may include a plurality of longitudinal reinforcing fibers, or rovings, oriented along the longitudinal axis within the matrix of the composite part. The composite part may also include a reinforcing structure such as a permeable web of fibers, known as a mat. The matrix substantially surrounds the optional roving and mat in the composite part.

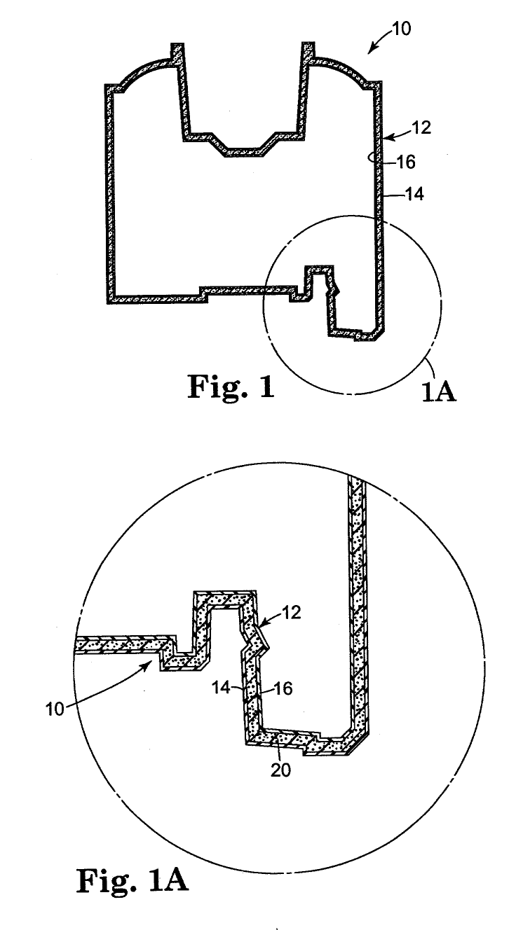

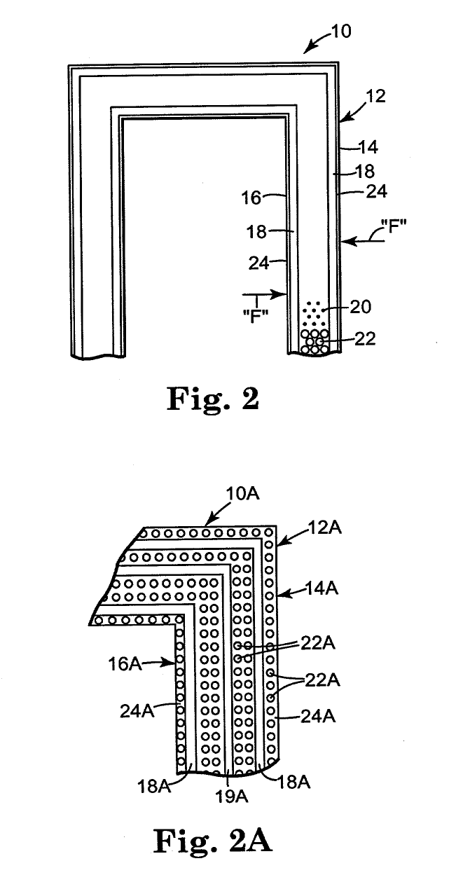

FIGS. 1 and 1A illustrate a pultruded part 10 for a fenestration product in accordance with the present invention. The part 10 is a hollow, closed, pultruded body 12 having uniformly spaced outer wall structure 14, an inner wall structure 16 and a matrix 20. Reinforcing mat is optionally included, and is typically located at or near wall structures 14 and 16 to increase transverse strength, although other configurations are possible (see FIG. 2A). In the embodiment of FIGS. 1 and 1A, the pultruded part 10 is a window sash rail section, although numerous fenestration and non-fenestration products may similarly be made using the present invention.

FIG. 2 illustrates a portion of the pultruded part 10 and an optional reinforcing mat 18. Pultruded body 12 has wall structures 14 and 16 each including the reinforcing mat 18 located on opposite sides of the matrix 20. The matrix 20 includes longitudinally extending rovings 22. The rovings 22 function to give the pultruded part 10 longitudinal strength and modulus. A reinforcing mat 18 provides the pultrusion walls 14 and 16 transverse strength to resist transverse forces “F” by locating transverse oriented reinforcing fibers in the part. The matrix 20 preferably surrounds and impregnates the longitudinal rovings 22 and the reinforcing mat 18. A relatively thin layer 24 of the matrix 20 covers the outer face of each of the reinforcement mats 18 to provide the desired surface characteristics.

FIG. 2A illustrates an alternate wall structures 14A and 16A for a pultruded part 10A in accordance with the present invention. A reinforcing mat 19A is located near the interior, rather than near the surfaces. In the illustrated embodiment, one or more layers of rovings 22A are positioned on both sides of reinforcing mats 18A and 19A. The pultruded part 10A exhibits alternating layers of reinforcing mats 18A, 19A and rovings 22A. A thin layer 24A of matrix material forms the surface of the wall structures 14A and 16A.

As illustrated in FIG. 2A, the layers of reinforcing mat and rovings may be arranged in a variety of configurations and the present invention is not limited to locating the reinforcing mat only on an outer surface of the pultruded part.

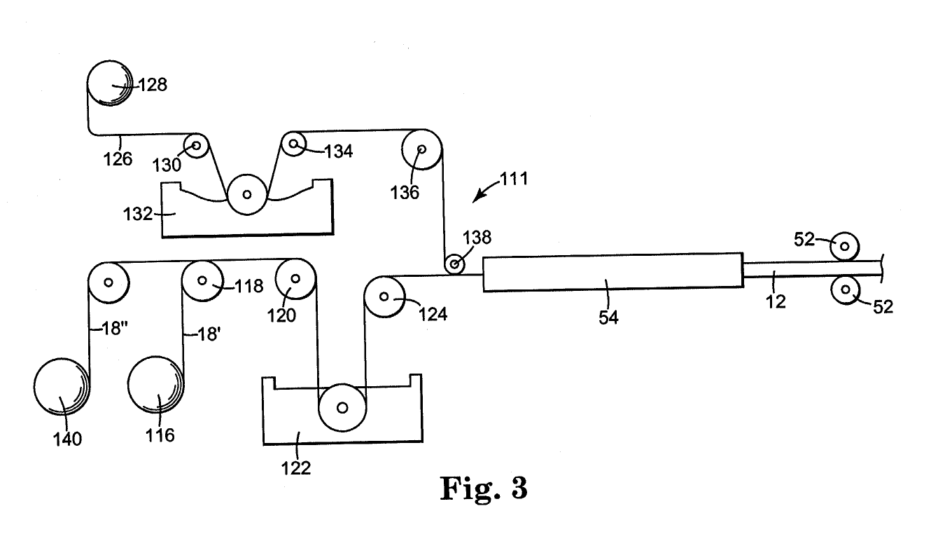

FIG. 3 schematically illustrates a pultrusion system 111 suitable for use with reinforcing mat and rovings to form a pultruded composite part in accordance with the present invention. One or more reinforcing mats 18′, 18″ (referred to collectively as “18”) are directed from source rolls 116, 140, respectively over illustrated rollers 118 and/or 120 to precursor bath 122. The wetted reinforcing webs 18 pass over roller 124 into the pultrusion die 54. A plurality of longitudinal rovings 126 from source roll 128 passes over roller 130, through precursor bath 132, and then over rollers 134, 136 and 138 into the die 54. The pultrusion die 54 typically has a profile corresponding to or otherwise needed to form the cross-sectional shape of the pultruded part 12. The longitudinal fibers are typically 675-yield (about 675 yards per pound), 450-yield, 250-yield, or 113-yield glass reinforcing fibers, although fibers with other yields or non-glass fibers may be used for some applications.

A variety of techniques well-known to one skilled in the art such as carding plates may be used to pre-form or pre-shape the rovings and the reinforcing mats 18 for pulling through the die 54. Prior to entering the die, the reinforcing mats 18 are preferably shaped to correspond generally with the profile of the die 54. Roll forming analogous to those used in forming sheet metal and/or heat-setting techniques may be used to shape the reinforcing mats 18. Other suitable methods for shaping the mats 18 are disclosed in U.S. Pat. No. 4,752,5134 to Rau et al. and U.S. Pat. No. 5,055,242 to Vane.

The rovings and the reinforcing mats are collated together for passage through the die but are generally not connected until unified by the matrix material. In another embodiment, the reinforcing mats 18 are attached to some of the longitudinal rovings 126, such as by stitching, adhesives and other attaching techniques. In yet another embodiment, the reinforcing mats 18 may be trapped between layers of rovings, such as illustrated in FIG. 2A. As the longitudinal rovings 126 are pulled through the die 54, the mats 18 are pulled along. The reinforcing mat 18 may be shaped using the same mechanisms used to position the longitudinal rovings 126 relative to the die 54.

Pulling mechanism 52, which for example may comprise a pair of opposing rollers, is operable to pull part 12 from a pultrusion die 54. Instead of passing the longitudinal rovings 126 and the reinforcing mats 18 through respective precursor baths 122, 132, as shown schematically in FIG. 3, the precursor composition may be applied to the reinforcing fiber and the reinforcing mats 18 using conventional resin-applying procedures that are well-known to those skilled in this art. Various techniques for making pultruded parts are reported in U.S. Pat. No. 4,564,540 to Davies et al., U.S. Pat. No. 4,752,513 to Rau, et al., U.S. Pat. No. 5,322,582 to Davies et al., and U.S. Pat. No. 5,324,377 to Davies.

The reinforcing fibers of the optional roving and mat are preferably compatible with the matrix material. As used herein, the term “compatible” refers to fibers and other components of a pultruded part in the environment of a precursor resin or matrix material that are selected or treated so that they facilitate penetration and essentially complete wetting and impregnation of the fiber and component surfaces by the precursor resin, provide desired physical properties of the cured or finished part, and are chemically stable within the precursor resin and matrix material.

In some embodiments, the optional roving and mat comprise glass fibers. Optionally, the fibers may be modified or treated to provide enhanced properties. By way of example, a glass fiber surface may be treated with an organosilane compound that acts as a coupling agent. As another example, the reinforcing fibers may be pre-coated with a thermoplastic synthetic resin or a crosslinkable polymer that may provide enhanced properties for the composite part. The terms “glass mat” and “glass roving” include mat and roving formed from glass fibers or glass fibers with surface modifiers.

One suitable mat for the practice of the present invention is a reinforcing structure that includes a permeable web of staple fibers attached to a plurality of first reinforcing fibers oriented so that the portion of the first reinforcing fibers oriented in a transverse direction comprises at least 40% of a volume of materials comprising the reinforcing structure. Glass fibers are preferred for this mat. One such mat is disclosed in U.S. patent application Ser. No. 10/015,106, filed Dec. 11, 2001, and a method for making such a mat is disclosed in U.S. patent application Ser. No. 10/015,093, filed Dec. 11, 2001. Other suitable mats are described, for example, by U.S. Pat. No. 5,908,689 to Dana, et al. and U.S. Pat. No. 5,910,458 to Beer, et al.

In alternative embodiments, the roving or mat of the composite part may comprise polymeric strands or fibers in addition to or in lieu of glass fibers. Polymeric fibers may be formed from one or more polymeric materials that are compatible with the matrix material and the precursor resin. Suitable man-made polymeric fibers may be formed from a fibrous or fiberizable material prepared from natural organic polymers, synthetic organic polymers or inorganic substances. Suitable man-made fibers include synthetic polymers such as aramid fibers, polyamides, polyesters, acrylics, polyolefins, polyurethanes, vinyl polymers, derivatives of these polymers, and mixtures thereof. Other inorganic fibers such as polycrystalline fibers, boron fibers, ceramics including silicon carbide, and carbon or graphite may be used in the optional mat or roving of the present invention. Suitable man-made fibers are generally formed by a variety of polymer extrusion and fiber formation methods, such as for example drawing, melt spinning, dry spinning, wet spinning and gap spinning.

A conventional pultrusion resin formulation may be used as the precursor resin for manufacturing the composite part. A typical precursor resin may include, for example, a mixture of thermoset polyester resin containing a reactive diluent such as styrene, along with a hardener, a catalyst, inorganic fillers, a suitable surface modifier, and a die lubricant. Resins suitable for use as precursor resins are disclosed in U.S. Pat. No. 4,752,513 to Rau, et al., U.S. Pat. No. 5,908,689 to Dana, et al., and U.S. Pat. No. 5,910,458 to Beer, et al. Other components that may be included in a precursor composition are, for example, colorants or pigments, lubricants or process aids, ultraviolet light (UV) stabilizers, antioxidants, low-profile additives (LPA), other fillers, and extenders.

In some embodiments, the precursor resin includes a thermosetting resin. Thermosetting precursor resins useful in the present invention include thermosetting polyesters, acrylics, vinyl esters, epoxides, phenolics, aminoplasts, thermosetting polyurethanes, derivatives and mixtures thereof. Suitable thermosetting polyesters include the AROPOL products that are commercially available from Ashland Specialty Chemical Co. (Covington, Ky.). Examples of useful vinyl esters include DERAKANE products such as DERAKANE 470-45, that are commercially available from Dow Chemical USA (Midland, Mich.). Examples of suitable commercially available epoxides are EPON 826 and 828 epoxy products, which are epoxy-functional polyglycidyl ethers of bisphenol-A prepared from bisphenol-A and epichlorohydrin and are commercially available from Shell Chemical (Houston, Tex.).

Non-limiting examples of suitable phenolics include phenol-formaldehyde commercially available from Monsanto (St. Louis, Mo.), cellobond phenolic commercially available from Borden (Columbus, Ohio), and specific phenolic systems formulated for pultrusion that are commercially available from BP (Chicago, Ill.), Georgia-Pacific (Atlanta, Ga.), and Inspec (Laporte Performance Chemicals) (Mount Olive, N.J.). Useful aminoplasts include urea-formaldehyde and melamine-formaldehyde such as RESIMENE 841 melamine formaldehyde, commercially available from Monsanto (St. Louis, Mo.). Suitable thermosetting polyurethanes include Adiprene PPDI-based polyurethane commercially available from Uniroyal Chemical Company, Inc. (Middlebury, Conn.) and polyurethanes that are commercially available from Bayer (Pittsburgh, Pa.), Huntsman (Edmonton, Alberta), and other resin formulators such as E. I. du Pont de Nemours Co. (Wilmington, Del.).

In other embodiments, the precursor resin may include a thermoplastic. Suitable thermoplastics include, for example, high-density polyethylene, low-density polyethylene, polypropylene, polystyrene, vinyl, acrylic, polycarbonate, polyamide, acetal, polyphenylene-sulfide, acrylonitrile-styrene-acrylate, and derivatives and mixtures thereof. Useful polyamides include, for example, the VERSAMID products that are commercially available from General Mills Chemicals, Inc. (Minneapolis, Minn.).

The composite parts of the present invention have coated, hollow microspheres incorporated into the precursor composition from which the composite part is molded. Hollow polymeric microspheres are commercially available in unexpanded (i.e., expandable) or pre-expanded forms. Pre-expanded microspheres are preferable for the practice of the present invention, but either type is suitable.

The microspheres used in the present invention are hollow, generally spherical shells coated on the exterior surface. As used herein, the term “microsphere” denotes particles of such a size that the particles may be incorporated into the matrix of the composite part without increasing the surface roughness of the part, relative to a part made without the microsphere component. A practical upper limit on the particle size is 250 microns.

The exterior coating on the microspheres is preferably compatible with the precursor resin to provide wetting of the exterior surface by the precursor resin. Inorganic ceramic coatings are suitable. A particular coating material suitable for use in the present invention is a metal carbonate such as calcium carbonate. Other coatings, such as gypsum powder, talc, calcium sulfate, barium sulfate, titanium dioxide, zinc oxide, zinc sulfide, alumina, carbon black, kaolin, feldspar, mica, graphite, milled fiberglass, silica, perlite, and wollastonite may also be suitable.

Microspheres having a polymeric shell are also suitable. A polymer especially suitable is polyvinylidene chloride (PVDC). Other thermoplastics may also be suitable. Coated and pre-expanded PVDC microspheres suitable for the practice of the present invention are available commercially, under the trade name DUALITE, from Pierce and Stevens Corp. (Buffalo, N.Y.), particularly DUALITE M6001 AE03. DUALITE M6001 AE03 Grade Polymeric Microspheres have a hollow PVDC shell coated with calcium carbonate, and are characterized by a density of 0.130 (±0.02) grams/cm3 and a particle size distribution curve having a mode (i.e., a peak in a size distribution curve) in the range of about 40-45 microns.

Various grades of uncoated, unexpanded PVDC microspheres are available commercially under the trade name MICROPEARL from Pierce and Stevens Corp. Suitable alternatives include hollow phenolic microspheres or hollow acrylic microspheres, for example. An uncoated hollow phenolic microsphere product is commercially available under the trade name PHENOSET through Eastech Chemical (Philadelphia, Pa.). PHENOSET BJO-0840 microspheres are characterized by a density of 0.10 to 0.15 grams/cm³ and a particle size distribution curve having a mode at about 70 microns. PHENOSET BJO-0930 microspheres are characterized by a maximum density of 0.104 grams/cm³ and a particle size distribution curve having a mode at about 90 microns. An uncoated hollow acrylic microsphere product is commercially available in pre-expanded or unexpanded forms under the trade name EXPANCEL from Akzo Nobel (Sundsvall, Sweden), in a variety of sizes and grades. Uncoated microspheres must first be coated in order to be useful in the practice of the present invention.

Uncoated microspheres are not suitable for use in the compositions and processes of the present invention. When uncoated, hollow polymeric microspheres (MICROPEARL F series) are combined with polyester resin, for example, the uncoated microspheres are generally incompatible with the resin and do not mix readily. In some instances, other problems may be encountered when uncoated microspheres are incorporated into a resin. For example, certain combinations of uncoated polymeric microspheres and resins may result in the microspheres dissolving into the resin. Also, uncoated microspheres may not have sufficient density to be mixable into a resin. Furthermore, composite pultruded parts incorporating uncoated, hollow microspheres did not exhibit the desired surface smoothness that is provided when coated, hollow microspheres are used, as described below.

Coatings may be applied to the exterior surface of uncoated, hollow microspheres using known processes to obtain coated, hollow microspheres suitable for use in the practice of the present invention. Methods for coating uncoated, hollow microspheres to obtain coated, hollow microspheres are disclosed, for example, in U.S. Pat. No. 4,722,943 to Melber, et al., U.S. Pat. No. 5,180,752 to Melber, et al., and U.S. Pat. No. 6,225,361 to Nakajima, the disclosures of which are hereby incorporated by reference in their entirety.

By way of example, U.S. Pat. No. 4,722,943 discloses a method of drying expandable thermoplastic microspheres by mixing “wet cake” (i.e., unexpanded microspheres in water) with a processing aid, such as talc, and heating to dry the wet cake and to produce microspheres having the processing aid embedded in or adhered to the surface. U.S. Pat. No. 5,180,752 discloses a method of drying, coating and expanding expandable thermoplastic microspheres by mixing wet cake with a surface barrier coating material to dry the wet cake, and heating the mixture to expand the microspheres and thermally bond the surface barrier coating material to the microsphere surface. Surface barrier coating materials suitable for the practice of that method include talc, calcium carbonate, alumina and titanium dioxide. U.S. Pat. No. 6,225,361 discloses a method of coating expanded thermoplastic microspheres with colloidal calcium carbonate. The colloidal calcium carbonate has particle size less than approximately 0.10 micron, and may be treated with a surface-treating agent or dispersing agent such as a fatty acid, polymer acid, sulfonic acid or carboxylic acid reagent.

In the practice of the present invention, the coated microsphere component is incorporated into the precursor composition at 0.001-80 parts per hundred (100) parts precursor resin on a mass/mass basis, preferably in the range 1-20 parts per hundred parts resin. By way of example, incorporation of the microsphere component at 3.8 pph (i.e., 3.8 grams microsphere component: 100 grams resin component) was sufficient to yield the desirable properties of the present invention.

The microsphere component is incorporated into the precursor resin by shear mixing at a temperature suitable for the precursor resin to be mixable. Shear mixing may be accomplished using a dough hook mixer or paddle mixer, or any other suitable mixing device. The mixing process must be carried out so that the integrity of the hollow microspheres is preserved.

In addition to the microspheres, a low-profile-additive (LPA) may optionally be incorporated into a precursor. An LPA is useful in reducing the shrinkage of a matrix formed from the precursor. A suitable LPA is polyvinyl acetate, such as LP-40 provided by Ashland Chemical. The use of LPA is cumulative with the use of the microspheres in reducing resin shrinkage, and creating a smooth surface on the composite profile.

The precursor may contain filler material, in addition to the coated, hollow microsphere component. The filler material may be any suitable filler used in a resin system of the type being produced. Fillers and pigments such as calcium carbonate, titanium dioxide, hydrated alumina, kaolin clay, silicon dioxide, carbon black and the like may be used. Wood flour, recycled plastic grinds, metal grinds such as VALIMET H2 spherical aluminum powder or HOEGANAES ANCOORSTEEL 1000 atomized steel powder, fly ash, or the like, may also be used to reinforce or fill the matrix material of the composite part, to obtain improved mechanical properties, to improve aesthetics, to increase or decrease density, or to reduce cost. Wood fibers may be employed to achieve a natural-wood color in the composite part, in addition to enhanced strength and lowered material cost.

The composite parts of the present invention having a matrix and coated, hollow microspheres exhibit reduced susceptibility for thermally induced shrinkage. The microsphere component replaces other materials or components that are more prone to shrink and expand with changes in temperature. Dimensional stability is an important feature in composite parts such as those used as structural members in fenestration components, since fenestration components are generally exposed to the elements and will experience repeated heating/cooling cycles.

Furthermore, dimensional stability under temperature changes is also an important consideration during the processing of molded parts, especially pultruded composite parts that are cured by the application of heat. Matrix materials that are prone to shrink and expand with changes in temperature may leave residual stress in the composite part. On the other hand, dimensionally stable matrix materials will not induce residual stresses in the composite part.

The composite parts of the present invention also are characterized by decreased density, relative to a composite part having a matrix that does not have a hollow microsphere component. The hollow microspheres replace the typically more dense resin material that makes up the matrix. Due to the decreased density, a fenestration component formed from the composite parts of the present invention will have reduced overall weight and will use less material, thus reducing shipping costs and raw material costs. The cost of the precursor resin can account for about 40-60% of the materials cost for a typical pultruded composite part. Adding the hollow microsphere component to the precursor resin reduces the cost per part.

Certain processing advantages may be realized by incorporating the coated, hollow microspheres into the precursor composition. It has been observed that the viscosity of the precursor resin under shear is decreased by the addition of the coated, hollow microspheres. For the manufacture of pultruded composite parts, the decrease in viscosity permits the pultrusion process to be carried out at decreased pressure in the forming die, relative to the manufacture of a pultruded part when no microsphere component is used. A lower pull force may also be used in the pultrusion process, resulting in decreased residual stress in the pultruded composite part.

In a first embodiment, the present invention is a pultruded composite part comprising a matrix and coated, hollow microspheres. The pultruded composite part of this embodiment may be manufactured using the precursor compositions containing precursor resin and microsphere components as described herein. For some applications, the pultruded composite part will include mat and roving, preferably glass mat and glass roving. The pultruded composite part of this embodiment may especially be useful as a fenestration component.

The pultruded composite part is made using known pultrusion processes, such as, for example, the pultrusion process described above. In a pultrusion process currently practiced, the precursor resin may be subjected to a temperature of 400° F. in the forming die, and a pressure of approximately 500 p.s.i. The DUALITE M6001 AE03 microsphere component, for example, is reported to have a thermal capability of 250° F., according to trade literature provided by Pierce and Stevens Corp. The resin typically exotherms at about 325° F. after exiting the die, and then cools to ambient temperature. These processing parameters, although outside the range suggested by the DUALITE trade literature, have given satisfactory results in forming a pultruded composite part.

In a second embodiment, the present invention provides a composite part comprising a matrix and a plurality of coated, hollow microspheres dispersed throughout the matrix. The composite part has an exterior surface characterized by an arithmetic mean roughness of less than about 55 microinches. The matrices and the microsphere components described above are suitable in the practice of this aspect of the present invention.

This embodiment of the invention includes composite parts formed by pultrusion, and also composite parts formed by other methods suitable for making molded composite parts. Other methods of making molded thermoset composite parts include resin transfer molding (RTM), compression molding (CM), structural reaction injection molding (SRIM), and sheet molding compound (SMC). These processes are all closed-molding operations, and do not emit significant volatile organic compounds, such as styrene.

Alternative methods of making molded thermoplastic composite parts include, for example, thermoplastic tape lay-up, thermoplastic pour molding, low-pressure injection molding, trimming operations or other low-shear processes. Low-shear processes are preferred in the practice of the present invention so that most of the microspheres are not destroyed by the pressure of the process. Increased smoothness of surface may be achieved for thermoplastic processing by the practice of the present invention.

The composite part of this embodiment may comprise a coated exterior surface. The coating is typically applied as a liquid-based product that may dry or cure to yield a coating layer. By way of example, the coating may be a paint, primer or other finish coat such as a clear coat. The coating may generally be applied to the exterior surface by any known method, such as by spraying. A coating may be applied to the exterior surface “in-line,” meaning that it is applied within a portion of a molding die, or a coating may be applied “off-line” following a molding process. The coated exterior surface may be suitable as a finished surface, or may be further processed to yield a finished surface.

As used herein, the phrase “surface roughness” references only the roughness of a surface for which it is desirable to achieve a finished surface. For a fenestration component, for example, the surface of interest would generally be the exposed exterior surface on which a coating would typically be applied.

Microscale defects in a finished surface of a composite material can result from shrink holes, or high-porosity areas where the resin has attempted to shrink from the surface, especially in areas furthest from interstices of fibers, and resulting in pits, generally 10 to 2000 microns deep, measured from the plane of the “peaks” of the surface. Other characteristic defects are surface roughness due to high porosity, usually occurring at the site of a pultrusion die purge, or the like, where insufficient resin is made available to fill in the resin-rich surface area of the composite, resulting in sloughing at the surface, where the part is dull, has high porosity, or is rough, due to lack of die-wall pressure during processing and especially during cure. A purge, in pultrusion, occurs when the pulling operation is paused, allowing the cure profile to migrate upstream, so that the die can be scoured by the cured composite, when the pulling operation is restarted.

Surface roughness may be measured as an arithmetic mean roughness, denoted Rₐ. A measured arithmetic mean roughness provides the average deviation of peak heights and valley depths from the average surface level. The arithmetic mean roughness is defined as the average absolute value deviation from the mean surface level, measured along a line parallel to the surface plane. The mean surface level is a threshold that is parallel to the surface plane, and is set at a height such that the area of the peaks of material above the mean surface level is equal to the area of the valleys (i.e., the absence of material) below the mean surface level. Rₐ is given by the integral equation

Rₐ=1/L∫|y(x)|dx (Equation 1)

where L denotes the length of the sample line, and |y(x)| denotes the absolute value of the surface height at point x relative to the mean surface level. An arithmetic mean roughness measurement has dimension of length, and is commonly given in microinches (0.000001 inches).

The measurement Rₐ, as given in Equation 1, is specified as the standard surface roughness measurement according to ASME B46.1-1995. Surface roughness measurements were made for composite parts produced according to the present invention, and for commercially available fenestration products, according to ASME B46.1-1995. The Profilometer used for these measurements was a BENDIX Type QE Model 1 Profilometer for Straight Line Tracing (similar to the current PDI SURFOMETER Series 400 available at Precision Devices, Inc., Milan, Mich.). Calibration was performed on a model PRS-1 three-patch master, consisting of calibration, linearity and diamond stylus condition patches traceable to NIST, or similar master.

Surface roughness was measured for a variety of fenestration products to determine the typical smoothness achieved. The data obtained is shown in Table 1. An important observation is that a roughness of 60 microinches for unpainted products, and 60 microinches for painted products, is presently the defacto roughness for current extruded aluminum fenestration products. A roughness of less than 60 microinches has not generally been achieved for unpainted and uncapped composite surfaces. It is desirable to provide roughness for an exterior finished surface on a composite part that is comparable to an exterior finished surface on an extruded aluminum fenestration product.

TABLE 1
Roughness of Various Fenestration Parts, Measured Per ASME B46.1-1995.

| | | Thickness | | Roughness, |
|---|---|---|---|---|
| | | (meas'd) | | Rₐ (meas'd) |
| Part | Direction | (inches) | Coating | (microinches) |
| Pella aluminum frame extrusion | longitudinal | 0.039 | none | 60 |
| Pella aluminum frame extrusion | longitudinal | 0.039 | paint | 60 |
| Pella aluminum sash rollstock | longitudinal | 0.024 | paint | 23 |
| PellaMat flat coupon #830 | longitudinal | 0.04 | none | 230 |
| PellaMat flat coupon #830 | transverse | 0.04 | none | 170 |
| RSI flat coupon | longitudinal | 0.08 | none | 29 |
| RSI flat coupon | transverse | 0.08 | none | 60 |
| RSI Viking stiffener | longitudinal | | none | 90 |
| Owens Corning mat profile | longitudinal | 0.08 | none | 35 |
| Owens Corning mat profile | transverse | 0.08 | none | 47 |
| PPG mat flat coupon | longitudianl | 0.08 | none | 120 |
| PellaMat profile | longitudinal | 0.055 | none | 70 |
| Pella Beta Sash profile | longitudinal | 0.075 | paint | 100 |
| Pella Precision Fit profile | longitudinal | 0.085 | paint | 200 |
| Pella Craftsman Sash profile | longitudinal | 0.055 | none | 150 |
| Injection molded Plastic Parts | | | as-molded | 60 |
| | | | surface | |
| Andersen vinyl clad profile | longitudinal | 0.02 | overwrapped | 9 |
| | | | vinyl | |
| | | | cladding | |
| Andersen Renewal profile | longitudinal | 0.12 | none | 90 |
| Marvin Integrity profile | longitudinal | 0.08 | none | 120 |
| (1998 vintage) | | | | |
| Marvin Integrity profile | longitudinal | 0.08 | painted | 110 |
| (1998 vintage) | | | | |
| Marvin Integrity wood interior | longitudinal | 0.08 | none | 90 |
| Marvin Integrity wood interior | transverse | 0.08 | none | 300 |
| Marvin Integrity sash slider capstock | longitudinal | 0.085 | capstock* | 45 |
| (2001 vintage) | | | | |
| Marvin Integrity sash slider capstock | transverse | 0.085 | capstock* | 31 |
| (2001 vintage) | | | | |
| Marvin Integrity frame slider capstock | longitudinal | 0.085 | capstock* | 40 |
| (2001 vintage) | | | | |
| Marvin Integrity frame slider capstock | transverse | 0.085 | capstock* | 40 |
| (2001 vintage) | | | | |
| Marvin Integrity sash capstock | longitudinal | 0.085 | capstock* | 35 |
| (2001 vintage) | | | | |
| Marvin Integrity sash capstock | transverse | 0.085 | capstock* | 40 |
| (2001 vintage) | | | | |
| Marvin Integrity frame DH capstock | longitudinal | 0.085 | capstock* | 47 |
| (2001 vintage) | | | | |
| Marvin Integrity frame DH capstock | transverse | 0.085 | captock* | 60 |
| (2001 vintage) | | | | |
| Marvin Integrity frame DH | transverse | 0.085 | no capstock | 120 |
| (2001 vintage) | | | | |
| Marvin Integrity Circlehead capstock | longitudinal | 0.085 | capstock* | 45 |
| Marvin Integrity Circlehead capstock | longitudinal | 0.085 | capstock* | 60 |
| Marvin Integrity Circlehead capstock | transverse | 0.085 | capstock* | 25 |
| Marvin Integrity Circlehead capstock | transverse | 0.085 | capstock* | 25 |
| Fiberglass Entry Door panel | longitudinal | 0.085 | paint | 29 |
| Finerglass Entry Door panel | transverse | 0.085 | paint | 27 |
| Fiberglass Entry Door panel | longitudinal | 0.085 | none | 80 |
| Fiberglass Entry Door panel | transverse | 0.085 | none | 65 |

*“capstock” indicates a layer of an acrylic on a substrate, generally made of fiberglass

It is also desirable to provide a comparable roughness for a finished surface on a fenestration component having a wall thickness of less than 0.085 inches. The composite part of this embodiment may be made with a wall thickness of about 0.075 inches or less, preferably about 0.055 inches or less, and more preferably about 0.040 inches. The composite part has reduced surface roughness, which can prevent defects from arising in a finished surface. By permitting the formation of a thin-walled composite part while retaining a defect-free surface for finishing, the present invention permits a reduction in the per-part cost of producing the composite parts, and reduces waste due to defective or rejected composite parts.

Table 2 demonstrates the results achieved for the composite pultruded parts of the invention using a coated, hollow microsphere component, as compared with composite parts made with a matrix filler of solid calcium carbonate. Composite pultruded parts made using coated, hollow microspheres are characterized by a surface roughness of 47 microinches Rₐ or less, prior to the application of any surface finish such as a coating, and surface roughness of 36 microinches Rₐ or less upon application of paint. In contrast, composite pultruded parts made using solid calcium carbonate are characterized by surface roughness of at least 55 microinches Rₐ, even after application of paint. The use of smaller particles of solid calcium carbonate was effective in decreasing surface roughness, but not as effective as the incorporation of the coated, hollow microspheres into the composite parts.

TABLE 2
Roughness Comparison of Current Pultrusion (SNOWHITE, 3 micron size
CaCO₃), Modified Pultrusion with Smaller Filler (1.5 micron CaCO₃), and
Pultrusion with Thermoplastic Microspheres (DUALITE M6001AE
Microspheres) per ASME B46.1-1995.

| | | No Paint | Pella Paint |
|---|---|---|---|
| Pultruded Part | | Rₐ | Rₐ |
| Description | Component or Filler | (microinches) | (microinches) |
| P30S-M6001 | 45 micron DUALITE | 44 | 36 |
| | M6001 | | |
| P30-M6001 | 45 micron DUALITE | 47 | 37 |
| | M6001 | | |
| P35-M6001 | 45 micron DUALITE | 47 | 27 |
| | M6001 | | |
| P30S-CaCO3 | 1.5 micron CaCO₃ | 55 | 58 |
| P35-CaCO3 | 1.5 micron CaCO₃ | 56 | 62 |
| P30-CaCO3 | 1.5 micron CaCO₃ | 57 | 55 |
| P30-snowhite | SNOWHITE* 3 | 150 | — |
| | micron CaCO₃ | | |
| P30-snowhite | SNOWHITE* 3 | 110 | — |
| | CaCO₃ | | |

*SNOWHITE is available from Omya (Perth, Ontario)

The present invention also provides a molded fenestration component comprising a matrix including coated, hollow microspheres. In some embodiments, the fenestration component is reinforced by mat and roving. The above-described resins and microspheres are suitable for use in the practice of this embodiment of the invention. The molded fenestration component of this embodiment of the invention includes components formed by pultrusion processes, and also components formed by other methods suitable for making molded components, examples of which are given above.

In another embodiment, the present invention provides a precursor that is useful for forming the composite parts and fenestration components of the present invention. The precursor is a mixture of a thermosetting resin and a plurality of coated, hollow microspheres, and a low-profile additive. The above-described resins, microspheres and low-profile additives are suitable for use in the practice of this embodiment of the invention.

A particular precursor formulation in accordance with this embodiment is given in Table 3. Coated, hollow microspheres are added to the precursor resin at about 5 pph and the low-profile-additive is added at about 20 pph. Mixing of this particular formulation may be done at room temperature.

TABLE 3
Precursor resin formulation for a preferred embodiment.

| | Amount | | | |
|---|---|---|---|---|
| Component | (pph*) | Description | Function | Source |
| AROPOL | 100 | isophthalic | resin | Ashland Specialty Chem. Co. |
| | | polyester | | (Covington, KY) |
| LP-40A | 20 | polyvinyl | low-profile | Ashland Specialty Chem. Co. |
| | | acetate | additive | (Covington, KY) |
| DUALITE M6001AE | 5 | coated, hollow | microsphere | Pierece and Stevens Corp. |
| | | microspheres | component | (Buffalo, NY) |
| INT-PS125 | 1 | release agent | internal | Axel Plastics |
| | | | mold release | (Woodside, NY) |
| LUCIDOL 256 | 0.5 | mid-range | catalyst | ATOFINA Chemicals |
| | | catalyst | | (Philadelphia, PA) |
| P16N | 0.5 | low-range | catalyst | Akzo Noebl Polymer |
| | | catalyst | | Chemicals (Chicago, IL) |

*parts per hundred parts resin, by weight

In yet another embodiment, the present invention includes a method for making a pultruded composite part. The method comprises: shaping glass roving to provide a shaped roving; contacting the shaped roving with a curable composition including coated, hollow microspheres to provide an impregnated roving; pulling the impregnated roving into a die to provide a green part; and curing the green part in the die to make a pultruded composite part. The precursor compositions of the present invention may be used as the curable composition in the practice of this method. A reinforcing glass mat may additionally be used in the practice of this method. The pultruded composite part produced by this method may especially be useful as a fenestration component.

The method of this embodiment is useful for producing the composite parts and fenestration components described by other embodiments of this invention by a pultrusion method, such as the method described above. In the practice of this method, the die is typically a heated forming die that may impart a profile to the green part. The heated forming die may also provide an environment in which the curable composition is cured, generally by the action of heat. A coating may optionally be applied to an exterior surface of the pultruded composite part in the practice of this method, either in-line or off-line.

The curable composition may be cured by the action of heat, causing crosslinking of a thermosetting precursor resin. Other methods of curing the curable composition include chemically initiated crosslinking; radiant curing methods such as infrared (IR), electron beam (e-beam), ultraviolet (UV), and radio frequency (RF) curing; and convective curing methods where a partially cured green part is reheated after exiting the die, to increase the degree of cure of a partially cured green part.

This invention, as set out in the appended claims, is not to be taken as limited to all of the details set out in this specification, as modifications and variations thereof may be made without departing from the spirit or scope of the invention.

What is claimed is:

1. A pultruded composite part having a matrix containing coated, hollow microspheres.

2. The pultruded composite part of claim 1 wherein the microspheres comprise a coating of a resin-compatible ceramic.

3. The pultruded composite part of claim 2 wherein the resin-compatible ceramic is a metal carbonate.

4. The pultruded composite part of claim 2 wherein the resin-compatible ceramic is calcium carbonate.

5. The pultruded composite part of claim 1 wherein the matrix comprises a cured polymer.

6. The pultruded composite part of claim 5 wherein the cured polymer is a polyester, acrylic, polyurethane, phenolic, polyamide, epoxide, vinyl ester, or aminoplast.

7. The pultruded composite part of claim 5 wherein the cured polymer is a cured polyester resin.

8. The pultruded composite part of claim 1 wherein the matrix comprises reinforcing fibers.

9. The pultruded composite part of claim 8 wherein the reinforcing fibers are glass fibers.

10. The pultruded composite part of claim 1 wherein the composite part has an exterior surface with an arithmetic mean roughness of less than about 55 microinches.

11. The pultruded composite part of claim 10 wherein the composite part is a fenestration component.

12. The pultruded composite part of claim 1 wherein the microspheres comprise a thermoplastic polymer.

13. The pultruded composite part of claim 12 wherein the thermoplastic polymer comprises polyvinylidene chloride.

14. The pultruded composite part of claim 1 wherein the microspheres have a particle size distribution mode in a range of about 40 to about 45 microns.

15. The pultruded composite part of claim 1, further comprising an applied coating on an exterior surface of the composite part.

16. The pultruded composite part of claim 15 wherein the coating on the exterior surface comprises paint or primer.

17. The pultruded composite part of claim I having a wall thickness of about 0.075 inches or less.

18. The pultruded composite part of claim 1 having a wall thickness of about 0.055 inches or less.

19. The pultruded composite part of claim 1 having a wall thickness of about 0.040 inches.

20. The pultruded composite part of claim 1 comprising:
a first plurality of rovings adjacent to a first surface of the pultruded composite part;
a second plurality of rovings adjacent to a second surface of the pultruded composite part; and
a reinforcing mat located between the first and second plurality of rovings.

21. The composite part of claim 1 comprising:
a first reinforcing mat adjacent to a first surface of the pultruded composite part;
a second reinforcing mat adjacent to a second surface of the pultruded composite part; and
a plurality of rovings located between the first and second reinforcing mats.

22. The pultruded composite part of claim 1 wherein the pultruded composite part is a fenestration component.

23. The fenestration component of claim 22 further comprising an applied coating on an exterior surface of the fenestration component.

24. A composite part comprising a matrix including a plurality of coated, hollow microspheres, the composite part having an exterior surface with an arithmetic mean roughness of less than about 55 microinches.

25. The composite part of claim 24 wherein the microspheres are coated with a ceramic.

26. The composite part of claim 24 wherein the microspheres are coated with calcium carbonate.

27. The composite part of claim 24 wherein the microspheres comprise a thermoplastic polymer.

28. The composite part of claim 27 wherein the thermoplastic polymer comprises polyvinylidene chloride.

29. The composite part of claim 24 wherein the microspheres have a particle size distribution mode in a range of about 40 to about 45 microns.

30. The composite part of claim 24 wherein the matrix comprises a cured polymer.

31. The composite part of claim 30 wherein the cured polymer comprises polyurethane, acrylic, polyester, polyamide, epoxide, vinyl ester, aminoplast or phenolic.

32. The composite part of claim 30 wherein the cured polymer is a cured polyester resin.

33. The composite part of claim 24 wherein the composite part further comprises reinforcing mat and roving.

34. The composite part of claim 33 wherein the reinforcing mat and roving comprise glass fibers.

35. The composite part of claim 24 further comprising an applied coating on the exterior surface.

36. The composite part of claim 24 having a wall thickness of about 0.075 inches or less.

37. The composite part of claim 24 having a wall thickness of about 0.055 inches or less.

38. The composite part of claim 24 having a wall thickness of about 0.040 inches.

39. The composite part of claim 24 wherein the composite part is a fenestration component.

40. The fenestration component of claim 39 wherein the matrix comprises crosslinked polyurethane, acrylic, polyester, polyamide, epoxide, vinyl ester, aminoplast or phenolic resin.

41. The fenestration component of claim 39 wherein the matrix is a cured polyester resin.

42. The fenestration component of claim 39 wherein the fenestration component further comprises reinforcing mat and roving.

43. The fenestration component of claim 42 wherein the reinforcing mat and roving comprise glass fibers.

44. The fenestration component of claim 39 comprising:
a first plurality of rovings adjacent to a first surface of the fenestration component;
a second plurality of rovings adjacent to a second surface of the fenestration component; and
a reinforcing mat located between the first and second plurality of rovings.

45. The fenestration component of claim 39 comprising:
a first reinforcing mat adjacent to a first surface of the fenestration component;
a second reinforcing mat adjacent to a second surface of the fenestration component; and
a plurality of rovings located between the first and second reinforcing mats.

46. The fenestration component of claim 39 having a wall thickness of about 0.075 inches or less.

47. The fenestration component of claim 39 having a wall thickness of about 0.055 inches or less.

48. The fenestration component of claim 39 having a wall thickness of about 0.040 inches.

49. The fenestration component of claim 39, further comprising an applied coating on the exterior surface.

50. The fenestration component of claim 49 wherein the coating on the exterior surface comprises paint or primer.

51. A precursor composition for making fenestration components comprising a curable mixture of:
a polymeric resin;
a plurality of coated, hollow microspheres; and
a low-profile additive.

52. The precursor of claim 51 wherein the microspheres are coated with calcium carbonate.

53. The precursor of claim 51 wherein the microspheres are polymeric beads.

54. The precursor of claim 53 wherein the polymeric beads comprise polyvinylidene chloride.

55. The precursor of claim 54 wherein the microspheres have a particle size distribution mode in a range of about 40 to about 45 microns.

56. The precursor of claim 51 wherein the polymeric resin is polyurethane, acrylic, polyester, polyamide, epoxide, vinyl ester, aminoplast or phenolic resin.

57. The precursor of claim 51 wherein the polymeric resin is a polyester resin.

58. The precursor of claim 51 wherein the low-profile additive is polyvinyl acetate.

59. A method of making a pultruded composite part comprising:
shaping strands of roving to provide a shaped reinforcement;
contacting the shaped reinforcement with a curable composition comprising coated, hollow microspheres to provide an impregnated reinforcement;
pulling the impregnated reinforcement into a die to provide a green part; and
curing the green part in the die to provide a pultruded composite part.

60. The method of claim 59 wherein the step of shaping further comprises shaping a mat with the roving to provide a shaped reinforcement.

61. The method of claim 60 wherein the mat and the roving comprise glass fibers.

62. The method of claim 61 wherein the roving contains glass fibers substantially aligned with a longitudinal axis of the pultruded composite part and the mat contains glass fibers substantially aligned crosswise to the longitudinal axis of the pultruded composite part.

63. The method of claim 59 wherein the pultruded composite part is a fenestration component.

64. The method of claim 59 further comprising applying a coating to an exterior surface of the pultruded composite part.

65. The method of claim 64 wherein the step of applying the coating to the exterior surface is done in-line.

66. The method of claim 64 wherein the coating applied to the exterior surface is paint or primer.

67. The method of claim 59 wherein the curable composition further comprises a curable polymer resin.

68. The method of claim 59 wherein the curable composition further comprises a curable polyester resin.
